(19) United States
(12) Patent Application Publication
(10) Pub. No.: US 2009/0314439 A1
(43) Pub. Date: Dec. 24, 2009

(54) WINDOW SHADE

(76) Inventor: Steve Waters, Buford, GA (US)

Correspondence Address: Ballard Spahr LLP, SUITE 1000, 999 PEACHTREE STREET, ATLANTA, GA, 30309-3915, US

(21) Appl. No.: 12/487,413

(22) Filed: Jun. 18, 2009

Related U.S. Application Data
(60) Provisional application No. 61/073,366, filed on Jun. 18, 2008.

(51) Int. Cl. E06B 9/68; E06B 9/24

(52) U.S. Cl. 160/84.02; 160/371; 160/309; 160/310

(57) ABSTRACT

A window shade apparatus that is configured to function in an aircraft. In one aspect, the shade apparatus has a frame defining an opening. The frame can vary in size and shape, as it is configured to substantially conform to an interior portion of the fuselage of an aircraft. The opening defined by the frame is, in one aspect, sized to substantially overlay at least one of the windows of the aircraft. Therefore, the frame substantially envelops the window and the opening permits viewing therethrough. The shade apparatus also has a shade that is configured to at least partially cover the opening and a drive mechanism to extend or retract the shade.

This application claims priority to and the benefit of U.S. Provisional Patent Application Ser. No. 61/073,366 filed on Jun. 18, 2008.

### FIELD OF THE INVENTION

The field of this invention relates generally to a window shade apparatus. More particularly, the invention is a window shade apparatus for use in an aircraft.

### BACKGROUND OF THE INVENTION

There are at least two styles of aircraft window shades in wide common usage today: solid plastic film used on almost all commercial airliners and some small private aircraft, and pleated, enclosed shades driven by electric motors, which are used in large private aircraft. One other conventional style is a non-enclosed pleated window shade operated by pulling a handle connected to the bottom of the pleats.

The pleated shades are much more attractive than the solid plastic film shades, but due to the fragility of the material they are very vulnerable to damage. Enclosing the pleats requires a more complex drive mechanism, which can exemplarily be motivated either manually or electrically. The larger, more expensive private jets generally have the enclosed, pleated, electric window shades, which are very expensive and have low reliability due to their complexity. In view of the preceding, there is a need for a simple manual drive mechanism for enclosed pleated shades that will be both reliable and low cost.

### SUMMARY

A window shade apparatus that is configured to function in an aircraft is presented. In one aspect, the shade apparatus comprises a frame defining an opening. The frame can vary in size and shape, as it is configured to substantially conform to an interior portion of the fuselage of an aircraft. The opening defined by the frame is, in one aspect, sized to substantially overlay at least one of the windows of the aircraft. Therefore, the frame substantially envelops the window and the opening permits viewing therethrough.

The shade apparatus also comprises a shade that is configured to selectively at least partially cover the opening. In one aspect, a portion of the shade can be selectively extended to substantially cover the entire opening. Optionally, the shade can also be configured to retract completely out of view and behind the front shell of the frame.

In another aspect, the shade apparatus also comprises a drive mechanism to extend or retract the shade. The drive mechanism, in one aspect, comprises a housing enveloping a substantially cylindrical roller. The roller is configured to rotate about its longitudinal axis within the housing. On at least one end of the roller, there can be a drive pulley connected thereto. In another aspect, a drive pulley can be connected to both ends of the roller. In one aspect, the drive pulley is configured to drive the cables in either direction to facilitate movement of the shade attachment and, in turn, the shade. Hence, when the roller rotates in a specific direction about its longitudinal axis, the drive pulleys will also rotate in that direction, thereby extending, or retracting the shade.

It is to be understood that both the foregoing general description and the following detailed description are exemplary and explanatory only and are not restrictive of the invention, as claimed.

### DETAILED DESCRIPTION OF THE FIGURES

The accompanying drawings, which are incorporated in and constitute a part of this specification, illustrate several aspects described below and together with the description, serve to explain the principles of the invention. Like numbers represent the same elements throughout the figures.

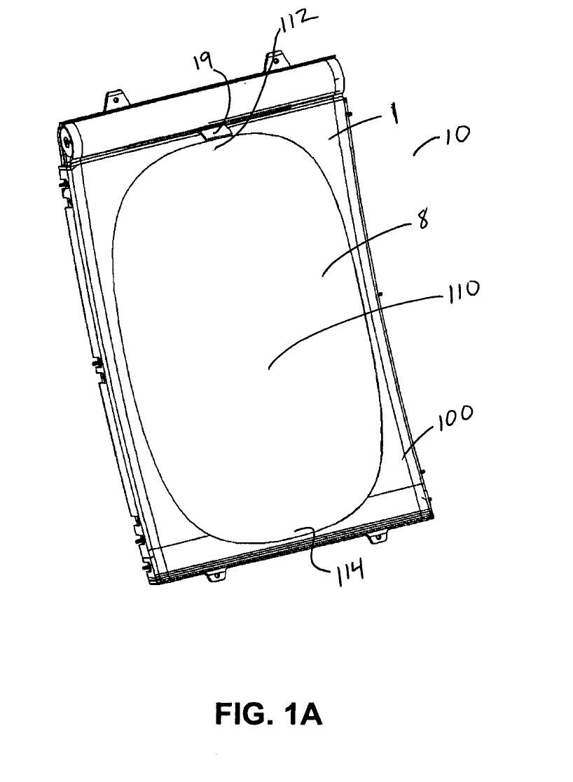

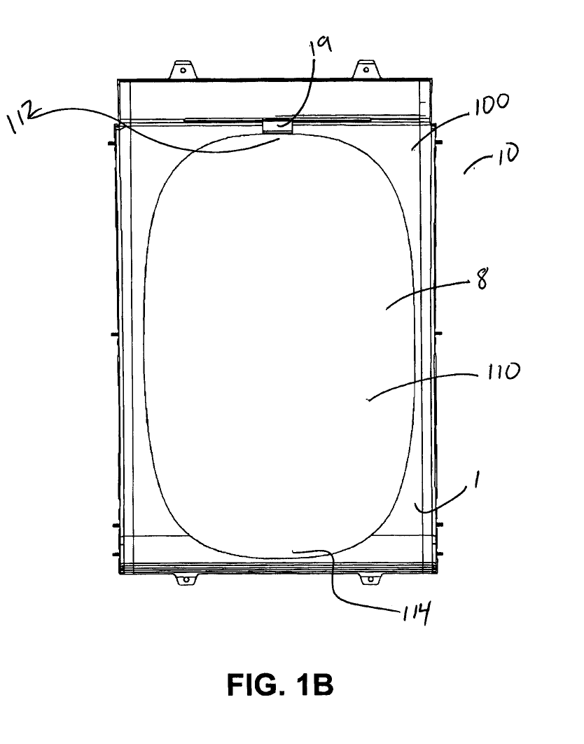

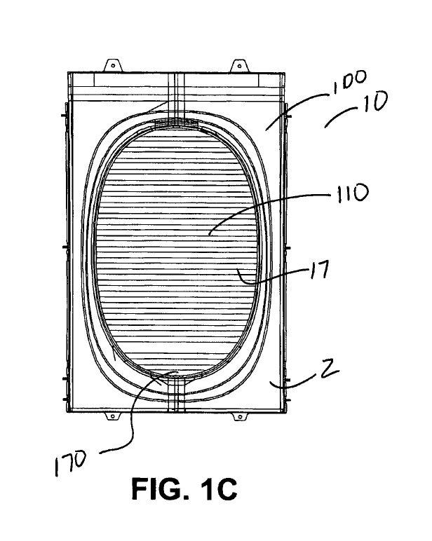

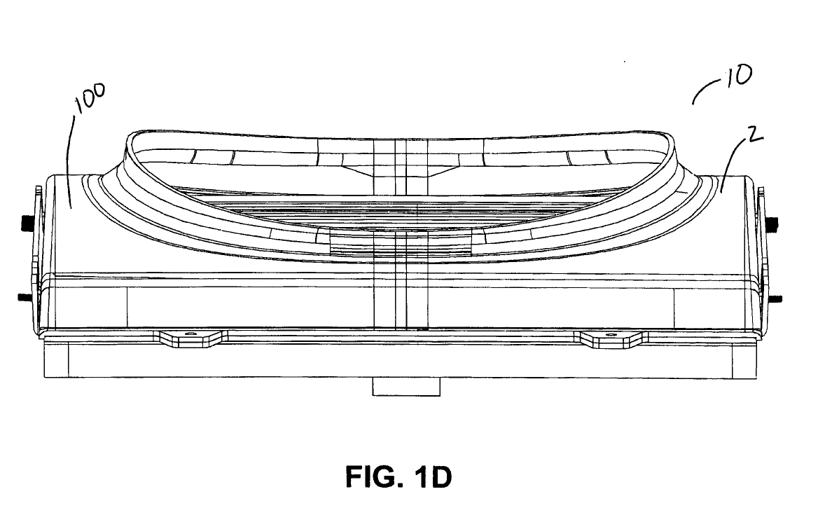

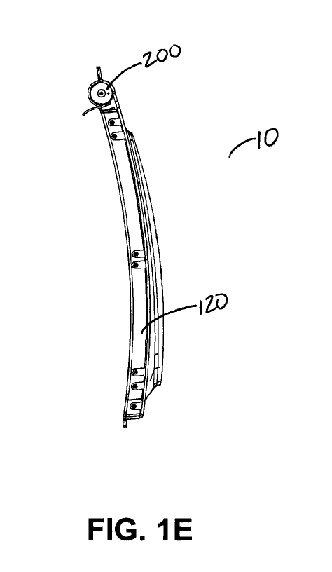

FIG. 1A is perspective view of one embodiment of the window shade apparatus.

FIG. 1B is a front elevational view of the window shade apparatus of FIG. 1A, showing the handle of the shade drive mechanism at the top-most portion of the window opening.

FIG. 1C is a back elevational view of the window shade apparatus of FIG. 1A.

FIG. 1D is a top elevational view of the window shade apparatus of FIG. 1A.

FIG. 1E is a side elevational view of the window shade apparatus of FIG. 1A.

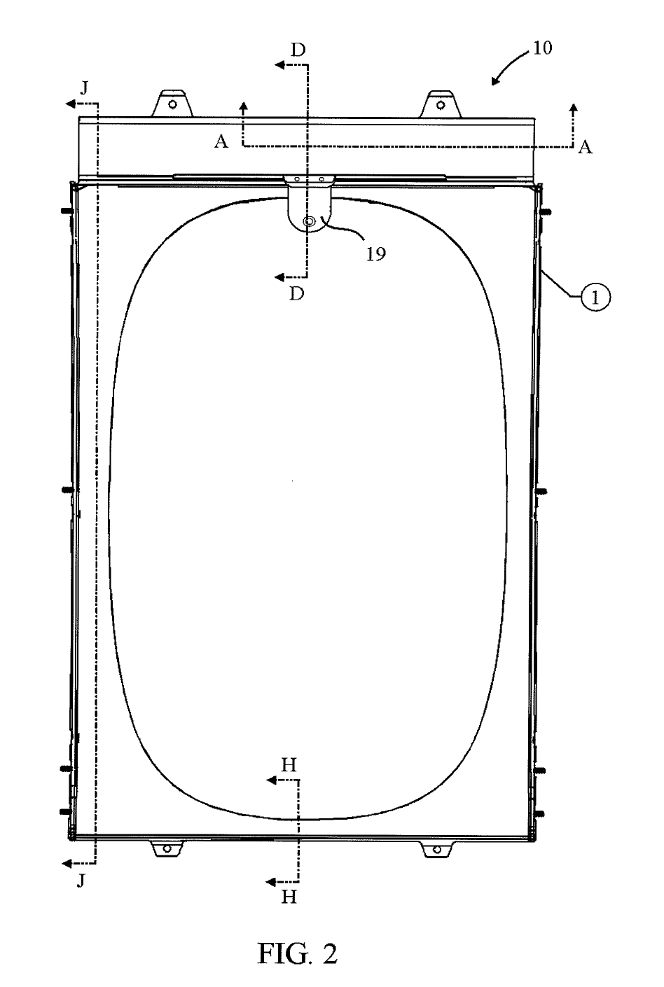

FIG. 2 is a front elevational view of the window shade apparatus of FIG. 1A.

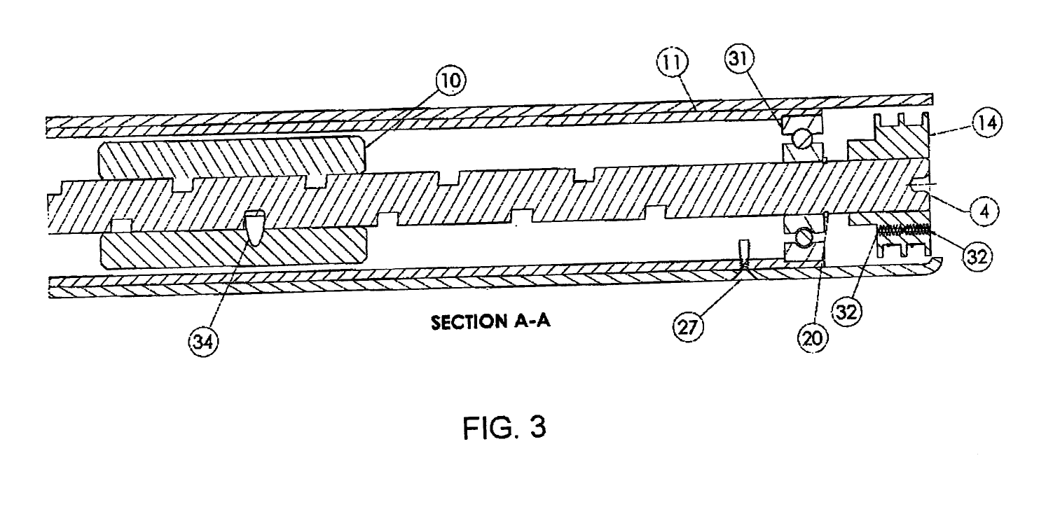

FIG. 3 is a partial sectional view of the window shade apparatus of FIG. 2, taken along line A-A, showing a roller mounted therein a housing and showing a slider operatively engaged with the spiral grooves formed therein the roller.

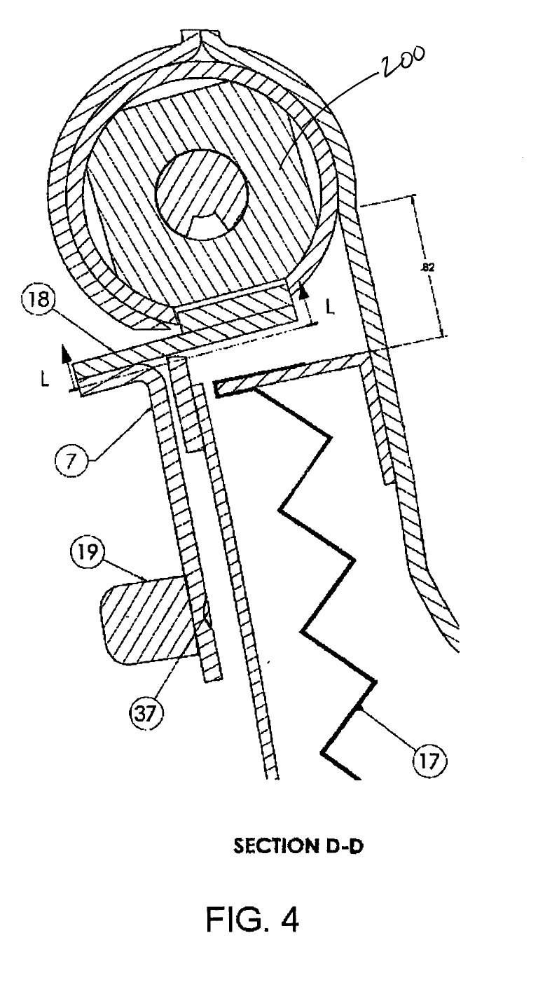

FIG. 4 is a partial sectional view of the window shade apparatus of FIG. 2, taken along line D-D, showing a handle and showing an end portion of the shade fixedly mounted therein a portion of the shade cavity.

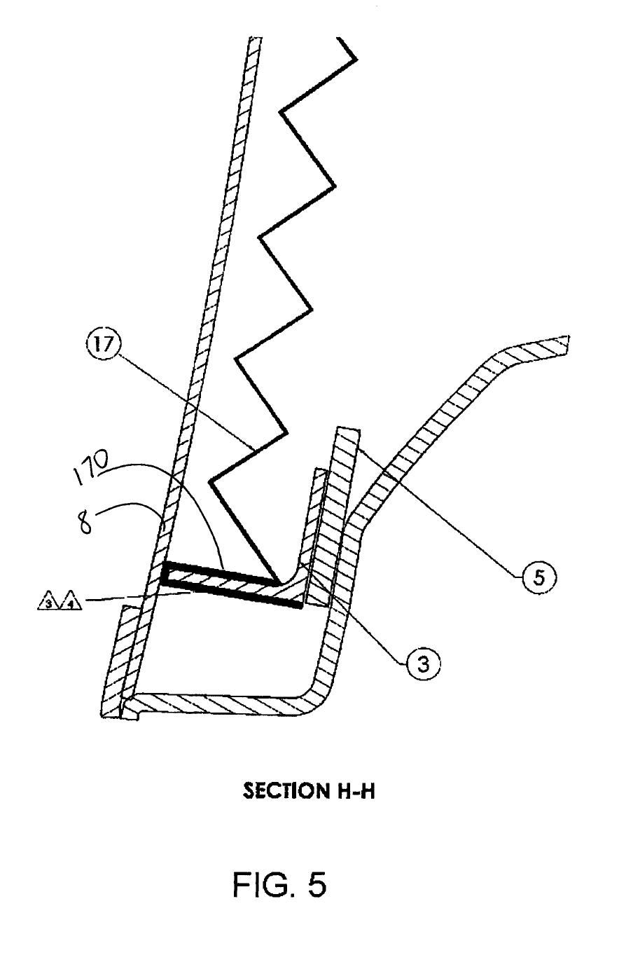

FIG. 5 is a partial sectional view of the window shade apparatus of FIG. 2, taken along line H-H, showing an end portion of the shade fixedly mounted thereto a selectively movable shade attachment.

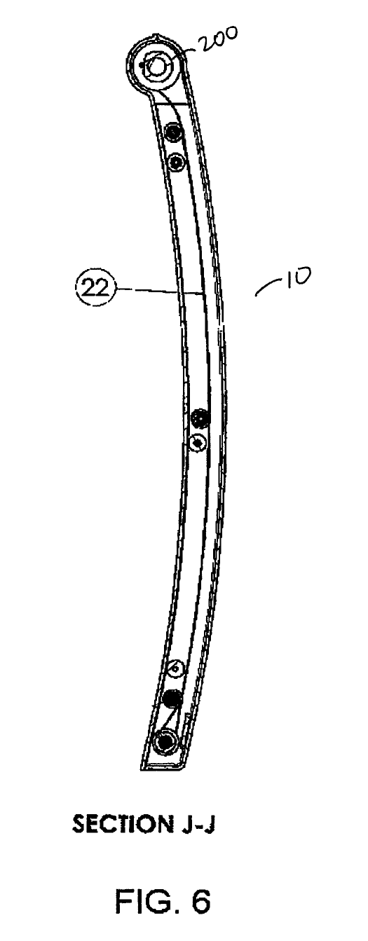

FIG. 6 is a partial sectional view of the window shade apparatus of FIG. 2, taken along line J-J, showing a cable operatively coupled to the shade attachment for selective movement of the shade.

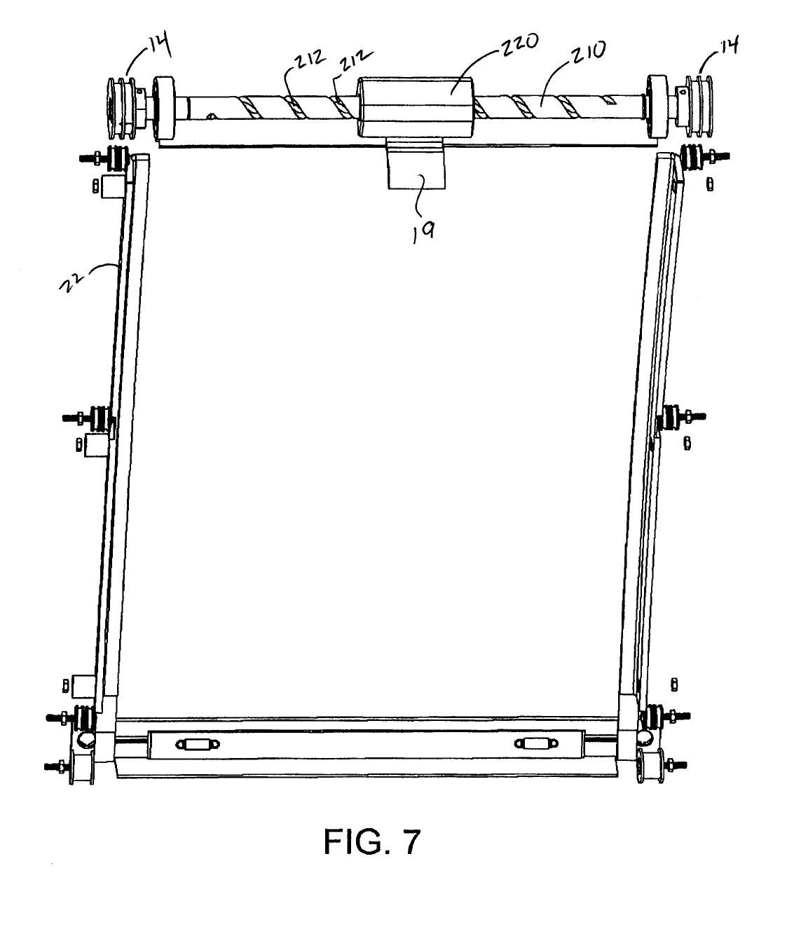

FIG. 7 is a schematic, exploded view of the window shade apparatus, showing various exemplary aspects of a drive mechanism for the window shade apparatus.

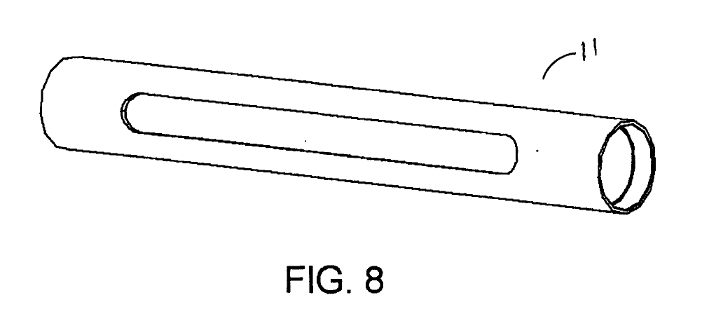

FIG. 8 is a perspective view of a housing configured to operatively receive a roller of the drive mechanism of the window shade apparatus, showing a slot defined therein the housing for operative receipt of at least a portion of the handle of the window shade apparatus.

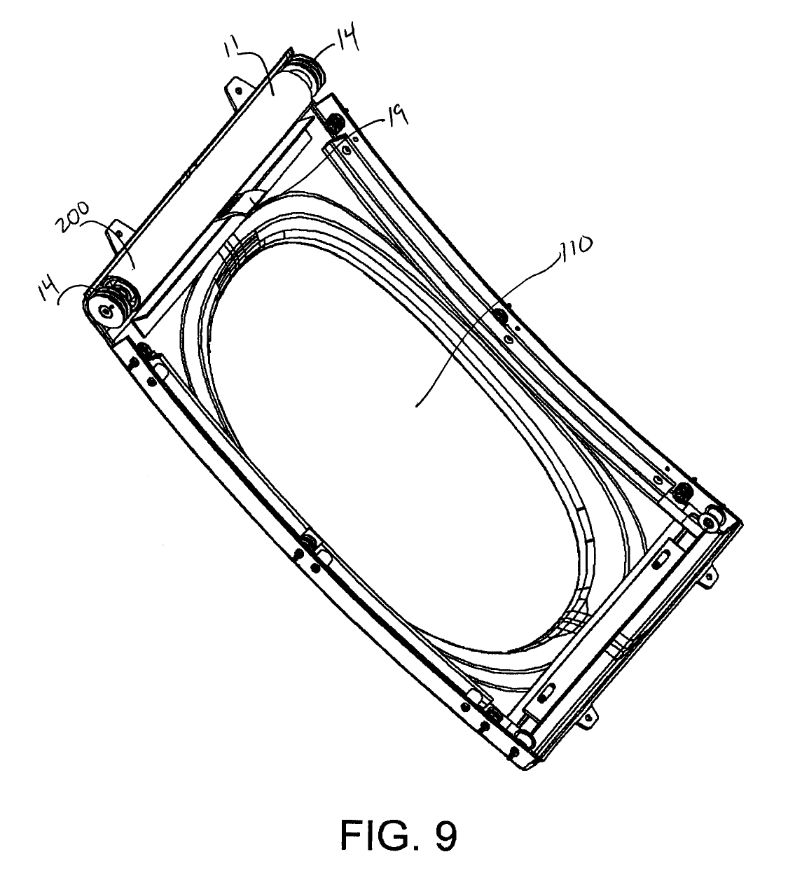

FIG. 9 is perspective view of the window shade apparatus with the front, inside shell removed.

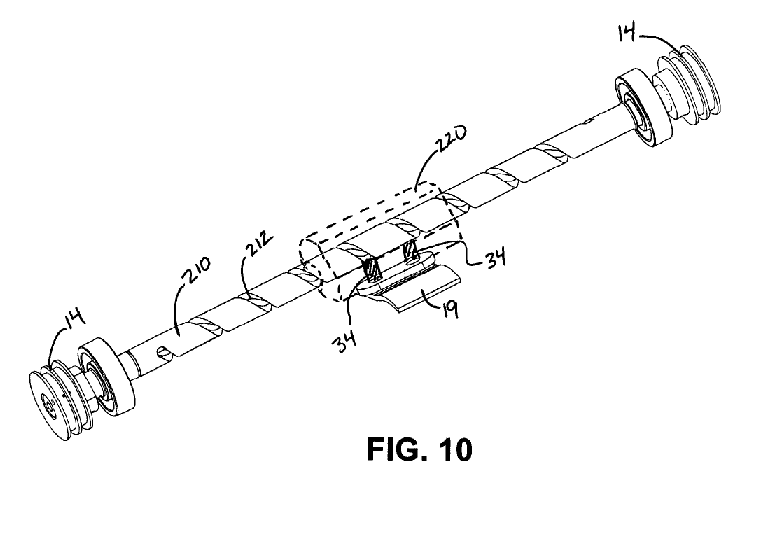

FIG. 10 is a perspective view of a portion of the drive mechanism, showing a partially transparent slider.

### DETAILED DESCRIPTION OF THE INVENTION

The present invention can be understood more readily by reference to the following detailed description, examples, drawing, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a window shade” can include two or more such structures unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance can or can not occur, and that the description includes instances where said event or circumstance occurs and instances where it does not.

A window shade apparatus 10 that is configured to function in an aircraft is presented. In one aspect, the shade apparatus 10 comprises a frame 100 defining an opening 110. The frame can vary in size and shape, as it is configured to substantially conform to an interior portion of the fuselage of an aircraft. As one skilled in the art will appreciate, the fuselages of different aircrafts can vary in radius of curvature, height, and length. Therefore, frames can be configured differently depending upon the aircraft for which it is intended.

The opening 110 defined by the frame 100 is, in one aspect, sized to substantially overlay at least one of the windows of the aircraft. Therefore, the frame substantially envelops the window and the opening permits viewing therethrough. In another aspect, the frame comprises a front shell 1 and a rear shell 2 and defines a cavity 120 therebetween the front shell 1 and rear shell 2. The shells can comprise a composite material, for example and not meant to be limiting, such as fiberglass cloth preimpregnated with epoxy or phenolic resin and cured under pressure and high temperature on a shaping form. In another aspect, the shells can comprise any rigid thermoplastic or thermoset which meets the performance requirements of the Federal Aviation Administration. Optionally, it is contemplated that any material that meets the performance criteria/requirements of the Federal Aviation Administration can be used for the formation of the shells.

In another aspect, the frame 100 can also comprise a substantially transparent front pane configured to cover the opening. In yet another aspect, the frame can also comprise a substantially transparent rear pane (not shown) that, together with the front pane 8 defines a narrow shade cavity. For example and without limitation, the front and rear panes can comprise LEXAN or some other comparably transparent substance.

The shade apparatus also comprises a shade 17 that is configured to selectively at least partially cover the opening. In one aspect, a portion of the shade 17 can be selectively extended to substantially cover the entire opening. The shade can optionally also be configured to retract completely out of view and behind the front shell of the frame. Alternatively, the shade can be configured to at least partially retract behind the front shell of the shade 17. In one exemplary aspect, the shade can be configured to a) retract upwardly to the top-most portion of the opening 110 and b) extend downwardly to the bottom-most portion 114 of the opening. In this aspect, it will be appreciated that a top portion of the shade is fixed at a point near the top most portion 112 of the opening. It is also contemplated that the shade could retract to a different portion of the opening. In another aspect, the shade 17 is configured to extend and retract within the shade cavity.

In another aspect, as shown in FIG. 3, the shade is pleated and the portion of the shade that retracts behind the front shell 1 of the frame folds in an accordion like fashion. This protects the shade 17 and gives it a cleaner appearance. For example and not meant to be limiting, the shade can comprise a fabric that can be specially treated for opacity and fire retardance.

In another aspect, the shade apparatus also comprises a drive mechanism 200 to selectively extend or retract the shade. In one aspect, the drive mechanism 200 is located substantially within the cavity 120 between the front and rear shells of the frame 100. At least a portion of the shade is connected to a portion of the drive mechanism. In one aspect, the shade apparatus 10 comprises an elongate shade attachment 3 that is attached to a bottom portion 170 of the shade. The shade attachment 3 is, in turn, operatively connected to the drive mechanism. As can be seen in FIG. 6, the shade attachment can be connected to the drive mechanism via a plurality of cables 22 and pulleys. In one aspect, there is a pair of cables, where a portion of each end of the elongate shade attachment is connected to a portion of the cable. 22. In this aspect, the cable, as can be seen in FIG. 6, forms a closed loop which, when pulled in a first direction, moves the shade attachment in a downward direction and, when pulled in a second, opposite direction, moves the shade attachment 3 in an upward direction. Since the bottom portion 170 of the shade is connected to a portion of the shade attachment, the shade is extended when the shade attachment moves in a downward direction and the shade retracts when the attachment moves in an upward direction. In another aspect, the respective ends of the shade attachment travel in a guide to ensure the correct travel path.

The drive mechanism 200, in one aspect, comprises a housing 11 enveloping a substantially cylindrical roller 210. The roller 210 is configured to rotate about its longitudinal axis within the housing 11. On at least one end of the roller, there can be a drive pulley 14 connected thereto. Optionally, a drive pulley 14 can be connected to each of the opposed ends of the roller. The drive pulley is configured to drive the cables in either direction to facilitate movement of the shade attachment 3 and, in turn, the shade. Hence, when the roller rotates in a specific direction about its longitudinal axis, the drive pulleys will also rotate in that direction, thereby extending, or retracting the shade.

In another aspect, the roller 210 defines a spiral groove 212 extending substantially from its first end to its second end about and around the outer surface of the roller. The groove 212 is configured such that adjacent portions of the groove along the longitudinal axis of the roller are spaced from each other a predetermined distance. The drive mechanism can also comprise a slider 220 equipped with one or more male protrusions 34 configured to at least partially complimentarily engage a portion of the spiral groove. In another aspect, as shown in FIG. 10, the slider 220 is equipped with two male protrusions 34 spaced from each other approximately the predetermined distance. In one exemplary aspect, the roller and slider can comprise, for example, acetyl or similar low friction rigid plastic. In this aspect, a handle 19 is connected to the slider for user interface.

In a further aspect, the housing can define, for example, a slot which is complimentary to the handle 19. In one aspect, the slot can extend substantially parallel to the longitudinal axis of the roller 210. The handle is configured to at least partially protrude through the slot and therethrough the front shell of the frame. In use, the handle can be moved to travel along the length of the slot, causing the slider to move along the length of the roller. Since the male protrusions 34 extending therefrom the slider 220 are engaged with the groove 212 in the surface of the roller, this action causes the male protrusions to travel within the groove and rotate the roller within the housing. This action, in turn, rotates the drive pulleys 14 and extends or retracts the shade. The pitch of the spiral of the groove determines the ratio of lateral movement of the slider 220 versus the distance the shade attachment extends. In one exemplary aspect, the ratio of shade travel to handle travel does not exceed 7:1.

It is contemplated that the shade apparatus can comprise two drive mechanisms on opposite ends of the opening 110. Each of the drive mechanisms 200 can be attached to and control separate shades. For example, one shade can be extended from the bottom toward the top of the opening, while the other shade can be extended from the top toward the bottom of the opening. In another aspect, the two shades can comprise different opacities so that a lightly tinted shade can be raised first, followed by a fully opaque shade.

It is further contemplated that the roller can be selectively driven by an electric motor that is operatively connected to the roller and an operator input device, such as conventional switch. Thus, via operator inputs to the switch, the movement of the roller and hence the shade can be selectively controlled.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

I claim:

1. A window shade system for a window of an aircraft comprising:
a frame defining an opening and configured to substantially conform to an interior portion of a fuselage of the aircraft and substantially envelop the window;
a front shell;
a rear shell, wherein the front shell and the rear shell define a cavity therebetween;
a shade configured to selectively at least partially cover the opening; and
a drive mechanism to selectively retract or extend the shade, wherein at least a portion of the shade is connected to at least a portion of the drive mechanism.

2. The window shade system of claim 1, wherein the shade is selectively extended to cover substantially the entire opening.

3. The window shade system of claim 1, wherein the shade is configured to retract upwardly to a top-most portion of the opening.

4. The window shade system of claim 1, wherein the shade is configured to retract downwardly to a bottom-most portion of the opening.

5. The window shade system of claim 1, wherein the shade is configured to retract within the shade cavity.

6. The window shade system of claim 1, wherein the shade is pleated.

7. The window shade system of claim 1, wherein the shade comprises a fire retardant material.

8. The window shade system of claim 1, wherein the drive mechanism comprises:
a housing;
a substantially cylindrical roller positioned within the housing and configured to rotate about a longitudinal axis within the housing;
a drive pulley connected to a portion of the roller; and
an elongate shade connector coupling the drive pulley to a portion of the shade; wherein rotation of the cylindrical roller in a first direction acts upon the drive pulley to move the shade in a downward direction and rotation of the cylindrical roller in a second direction acts upon the drive pulley to move the shade in an upward direction.

9. The window shade system of claim 8, further comprising a second drive pulley connected to a second portion of the roller.

10. The window shade system of claim 8, further comprising a handle connected to the drive mechanism, wherein translation of the handle along a path substantially parallel to the longitudinal axis of the roller rotates the roller.

11. The window shade system of claim 8, wherein the elongate shade connector is a cable.

12. The window shade system of claim 11, wherein the cable forms a closed loop.

13. The window shade system of claim 8, wherein the roller defines a spiral groove extending substantially from a first end of the roller to a second end of the roller about and around an outer surface of the roller.

14. The window shade system of claim 13, wherein the housing defines a longitudinal slot

15. The window shade system of claim 14, further comprising a slider comprising at least one male protrusion configured to at least partially complimentarily engage a portion of the spiral groove, wherein translation of the slider along the longitudinal slot causes the roller to rotate.

16. The window shade system of claim 15, wherein the slider comprises two male protrusions.

17. The window shade system of claim 15, further comprising a handle connected to the slider.

18. The window shade system of claim 17, wherein at least a portion of the handle is external to the housing.

19. The window shade system of claim 1, wherein the drive mechanism comprises an electric drive motor operatively connected to the roller.

20. The window shade system of claim 1, further comprising a substantially transparent front pane configured to cover the opening.

21. The window shade system of claim 20, further comprising a substantially transparent rear pane, wherein the front pane and the rear pane define a shade cavity therebetween.

22. The window shade system of claim 21, wherein at least one of the front pane and the rear pane comprise LEXAN.

23. A window shade system for a window of an aircraft comprising:
a frame defining an opening and configured to substantially conform to an interior portion of a fuselage of the aircraft and substantially envelop the window;
a front shell;
a rear shell, wherein the front shell and the rear shell define a cavity therebetween;
a shade configured to selectively at least partially cover the opening; and
a drive mechanism to selectively retract or extend the shade, wherein at least a portion of the shade is connected to at least a portion of the drive mechanism, and wherein the drive mechanism comprises:
a substantially cylindrical roller extending substantially horizontally and configured to rotate about a longitudinal axis;
an actuator coupled to the roller configured to travel in a longitudinal direction relative to the roller;
means for translating longitudinal motion imparted thereon the actuator to rotational motion of the roller to extend or retract the shade.
